(19) United States
(12) Patent Application Publication
(10) Pub. No.: US 2023/0297926 A1
(43) Pub. Date: Sep. 21, 2023

(54) METHODS, INTERNET OF THINGS SYSTEMS, AND STORAGE MEDIUMS FOR EXECUTION QUALITY EVALUATION OF SMART GAS WORK ORDERS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Yong LI, Chengdu (CN); Xiaojun WEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/323,401

(22) Filed: May 24, 2023

(30) Foreign Application Priority Data
Apr. 12, 2023 (CN) 202310384238.8

(51) Int. Cl. G06Q 10/0639; G06Q 50/06

(52) U.S. Cl. CPC G06Q 10/06395; G06Q 50/06

(57) ABSTRACT

Methods, Internet of Things (IoT) systems, and storage mediums for execution quality evaluation of a smart gas work order are provided. The method is executed by the IoT system for execution quality evaluation of a smart gas work order, including: classifying the work order based on operation data of the gas work order and determining a work order category; collecting work order execution data based on a video recorder and obtaining gas platform monitoring data through a material usage recording device; determining, based on at least one of the work order category, the work order execution data, or the gas platform monitoring data, an evaluation parameter; dynamically adjusting the evaluation parameter in response to a determination that the work order execution data or the gas platform monitoring data meets a preset condition; and determining, based on the evaluation parameter, an evaluation result.

### CROSS-REFERENCE TO RELATED APPLICATION

This application claims priority of Chinese Patent Application No. 202310384238.8, filled on Apr. 12, 2023, the contents of which are entirely incorporated herein by reference.

### TECHNICAL FIELD

The present disclosure relates to the field of gas operation, and in particular to, methods, Internet of Things (IoT) systems, and storage mediums for execution quality evaluation of smart gas work orders.

### BACKGROUND

As gas is more and more widely used in life, there are more and more demands related to the gas. People may make gas-related claims by submitting a gas work order to a gas company. At present, evaluation of execution quality of the gas work order mostly depends on evaluation of a customer. Due to a subjective nature of the customer evaluation, it is impossible to evaluate the execution quality of the gas work order truly and objectively.

Therefore, it is desirable to provide methods, Internet of Things (IoT) systems, and storage mediums for execution quality evaluation of smart gas work orders to provide a reasonable and true evaluation of the execution quality of the gas work order.

### SUMMARY

One or more embodiments of the present disclosure provide a method for execution quality evaluation of a smart gas work order. The method is executed by an IoT for execution quality evaluation of a smart gas work order, including: classifying the work order based on operation data of the gas work order and determining a work order category, the work order category including at least one of a work order type, a work order difficulty, a personnel demand situation, an actual executive situation, or a material demand situation; collecting work order execution data based on a video recorder and obtaining gas platform monitoring data through a material usage recording device; determining, based on at least one of the work order category, the work order execution data, or the gas platform monitoring data, an evaluation parameter, and the evaluation parameter includes at least one of a preset weighted full score, a preset item weight, a preset item full score, or an item actual score; dynamically adjusting the evaluation parameter in response to a determination that the work order execution data or the gas platform monitoring data meets a preset condition; and determining, based on the evaluation parameter, an evaluation result.

One or more embodiments of the present disclosure provide an IoT system for execution quality evaluation of a smart gas work order. The IoT system includes a smart gas user platform, a smart gas service platform, a smart gas management platform, and a smart gas sensor network platform and a smart gas object platform that interact in turn. The smart gas user platform is configured to issue a query instruction for gas operation management information to the smart gas management platform through the smart gas service platform. The smart gas management platform is configured to, in response to the query instruction for the operation management information, issue an instruction for obtaining gas device-related data to the smart gas object platform through the smart gas sensor network platform and receive the gas device-related data uploaded by the smart gas object platform; obtain the gas operation management information by processing the gas device-related data based on the smart gas management platform; and upload the gas operation management information to the smart gas user platform through the smart gas service platform. The gas device-related data at least includes work order execution data, the gas operation management information includes an evaluation result, and determining the evaluation result includes: classifying the work order based on the operation data of the gas work order and determining a work order category, the work order category including at least one of a work order type, a work order difficulty, a personnel demand situation, an actual executive situation, or a material demand situation; collecting the work order execution data based on a video recorder and obtaining gas platform monitoring data through a material usage recording device; determining, based on at least one of the work order category, the work order execution data, or the gas platform monitoring data, an evaluation parameter, and the evaluation parameter includes at least one of a preset weighted full score, a preset item weight, a preset item full score, or an item actual score; dynamically adjusting the evaluation parameter in response to a determination that work order execution data or the gas platform monitoring data meets a preset condition; and determining, based on the evaluation parameter, an evaluation result.

One or more embodiments of the present disclosure provide a non-transitory computer-readable storage medium storing computer instructions. When reading the computer instructions in the storage medium, a computer implements the method for execution quality evaluation of a smart gas work order as described above.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which the same reference numbers represent the same structures, wherein:

FIG. 1 is a schematic diagram illustrating an exemplary structure of an Internet of Things (IoT) system for execution quality evaluation of a smart gas work order according to some embodiments of the present disclosure;

FIG. 2 is a flowchart illustrating an exemplary process for execution quality evaluation of a smart gas work order according to some embodiments of the present disclosure;

FIG. 3 is a flowchart illustrating an exemplary process for determining an evaluation parameter according to some embodiments of the present disclosure;

FIG. 4 is a schematic diagram illustrating an exemplary processing process of a first score model according to some embodiments of the present disclosure; and

FIG. 5 is a schematic diagram illustrating an exemplary processing process of an operation loss evaluation model according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

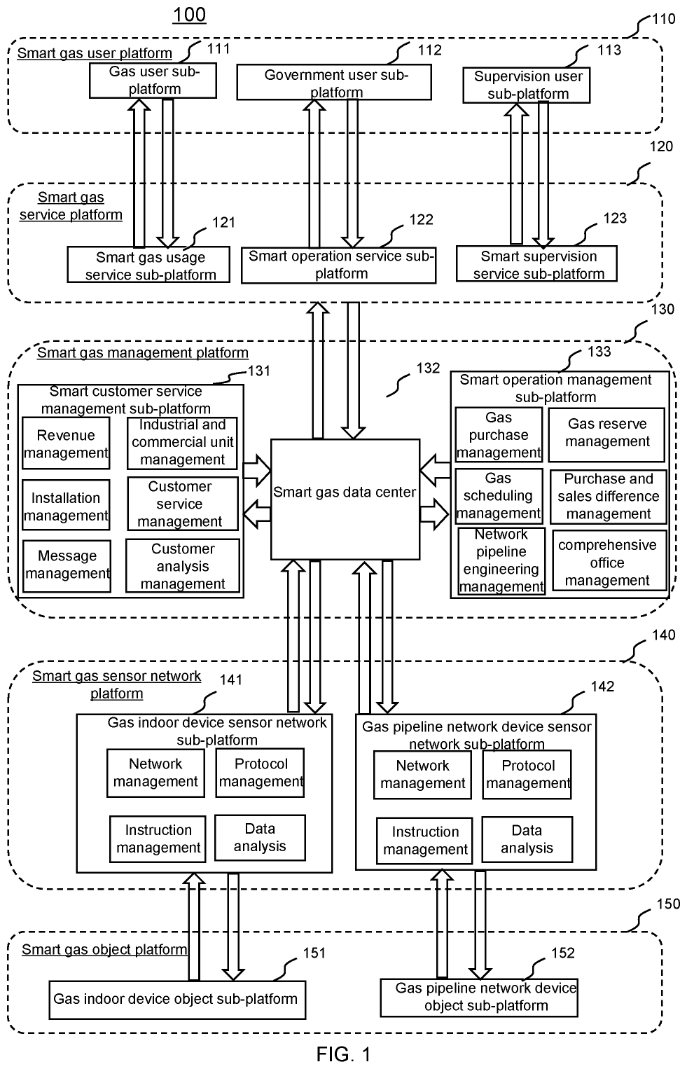

FIG. 1 is a schematic diagram illustrating an exemplary structure of an Internet of Things (IoT) system for execution quality evaluation of a smart gas work order according to some embodiments of the present disclosure.

In some embodiments, the IoT system 100 for execution quality evaluation of a smart gas work order includes a smart gas user platform 110, a smart gas service platform 120, a smart gas management platform 130, a smart gas sensor network platform 140, and a smart gas object platform 150.

The smart gas user platform is a platform configured to interact with a user. In some embodiments, the smart gas user platform may be configured as a terminal device.

In some embodiments, the smart gas user platform 110 may be configured to receive and transmit information and/or an instruction, and feedback the received information to the user. For example, the smart gas user platform 110 may send a query instruction for gas operation management information input by the user to the smart gas service platform 120 and obtain the gas operation management information fed back by the smart gas service platform 120. In some embodiments, the gas operation management information may include a gas work order evaluation result and gas work order acceptance information.

In some embodiments, the smart gas user platform 110 may include a gas user sub-platform 111, a government user sub-platform 112, and a supervision user sub-platform 113.

The gas user sub-platform 111 is configured to provide the gas user with data related to gas usage and a solution to a gas problem. In some embodiments, the gas user sub-platform 111 may perform an information interaction with a smart gas usage service sub-platform 121 of the smart gas service platform 120 to obtain a service reminder related to safe gas usage.

The government user sub-platform 112 is configured to provide data related to gas operation for a government user. In some embodiments, the government user sub-platform 112 may perform the information interaction with a smart operation service sub-platform 122 of the smart gas service platform 120 to obtain the data related to gas operation. For example, the government user sub-platform 112 may send the query instruction for gas operation management information to the smart operation service sub-platform 122. As another example, the government user sub-platform 112 may obtain the gas operation management information uploaded by the smart operation service sub-platform 122.

The supervision user sub-platform 113 is configured to supervise operation of the entire IoT system 100 for execution quality evaluation of a smart gas work order. In some embodiments, the supervision user sub-platform 113 may perform the information interaction with a smart supervision service sub-platform 123 of the smart gas service platform 120 to obtain a service required by safety supervision.

The smart gas service platform 120 may be a platform for receiving and transmitting data and/or information. In some embodiments, the smart gas service platform 120 may interact with the smart gas management platform 130 downwardly and issue the query instruction for gas operation management information to the smart gas management platform 130. In some embodiments, the smart gas service platform 120 may interact upwardly with the smart gas user platform 110 and upload the gas operation management information to the smart gas user platform 110.

In some embodiments, the smart gas service platform 120 may include the smart gas usage service sub-platform 121, the smart operation service sub-platform 122, and the smart supervision service sub-platform 123. The smart gas usage service sub-platform 121 may perform the information interaction with the gas user sub-platform 111; the smart operation service sub-platform 122 may perform the information interaction with the government user sub-platform 112; the smart supervision service sub-platform 123 may perform the information interaction with the supervision user sub-platform 113.

The smart gas management platform 130 refers to a platform that overall plans and coordinates connection and collaboration between various functional platforms, gathers all information of the IoT, and provides perception management and control management functions for the IoT operation system. In some embodiments, the smart gas safety management platform 130 may include a processing device and other components. In some embodiments, the smart gas management platform 130 may be a remote platform controlled by the user, an artificial intelligence, or a preset rule.

In some embodiments, the smart gas management platform 130 may include a smart customer service management sub-platform 131, a smart gas data center 132, and a smart operation management sub-platform 133.

In some embodiments, the smart customer service management sub-platform 131 may be configured for revenue management, industrial and commercial unit management, installation management, customer service management, message management, and customer analysis management.

In some embodiments, the smart operation management sub-platform 133 may be configured for gas purchase management, gas reserve management, gas scheduling management, purchase and sales difference management, network pipeline engineering management, and comprehensive office management. In some embodiments, the smart operation management sub-platform 133 may be configured to process gas device-related data, obtain the gas operation management information, and feedback the gas operation management information to the smart gas data center 132.

In some embodiments, the smart customer service management sub-platform 131 and the smart operation management sub-platform 133 may respectively perform a bidirectional interaction with the smart gas data center 132. For example, the smart customer service management sub-platform 131 and the smart operation management sub-platform 133 may respectively obtain data from and feedback the data to the smart gas data center 132.

In some embodiments, the smart gas management platform 130 may perform the information interaction with the smart gas service platform 120 and the smart gas sensor network platform 140 respectively through the smart gas data center 132. For example, the smart gas data center 132 receives the query instruction for gas operation management information issued by the smart gas service platform 120 and issues an instruction for obtaining the gas device-related data to the smart gas sensor network platform 140 in response to the query instruction. As another example, the smart gas data center 132 may receive the gas device-related data uploaded by the smart gas sensor network platform 140 and send the gas device-related data to the smart operation management sub-platform 133 for processing. As another example, the smart gas data center 132 may receive a processing result of the smart operation management sub-platform 133 and upload the processing result to the government user sub-platform 112 through the smart gas operation service sub-platform 122.

The smart gas sensor network platform 140 may be a functional platform for managing sensor communication. In some embodiments, the smart gas sensor network platform 140 may be configured as a communication network and gateway to implement functions such as network management, protocol management, instruction management, and data analysis, etc. In some embodiments, the smart gas sensor network platform 140 may perform the information interaction with the smart gas management platform 130 and the smart gas object platform 150. For example, the smart gas sensor network platform 140 may receive the gas device-related data uploaded by the smart gas object platform 150 and issue the instruction for obtaining the gas device-related data to the smart gas object platform 150.

In some embodiments, the smart gas sensor network platform 140 may include a gas indoor device sensor network sub-platform 141 and a gas pipeline network device sensor network sub-platform 142. The gas indoor device sensor network sub-platform 141 may correspond to a gas indoor device object sub-platform 151 and may be configured to obtain indoor device-related data (e.g., a metering device, etc.). The gas pipeline network device sensor network sub-platform 142 may correspond to a gas pipeline network device object sub-platform 152 and is configured to obtain data (all belong to the gas device-related data) related to a pipeline network device (e.g., a gas gate station compressor, a pressure regulating device, a gas flow meter, a valve control device, a thermometer, a barometer, etc.).

The smart gas object platform 150 may be a functional platform for perception information generation and control information execution. In some embodiments, the smart gas object platform 150 may be configured to include at least one gas device and at least one other device. The gas device may include an indoor device and a pipeline network device. The other device may include a monitoring device, a temperature sensor, a pressure sensor, etc. In some embodiments, the smart gas object platform 150 may interact upwardly with the smart gas sensor network platform 140, receive the instruction for obtaining the gas device-related data issued by the smart gas sensor network platform and upload the gas device-related data to the smart gas sensor network platform 140. In some embodiments, the gas device-related data may include gas meter measurement data and environmental monitoring data (e.g., an environmental temperature, an atmospheric pressure, etc.) and work order execution data recorded by a video recorder.

In some embodiments, the smart gas object platform 150 may include the gas indoor device object sub-platform 151 and the gas pipeline network device object sub-platform 152. The gas pipeline network device object sub-platform 152 may include the pipeline network device, and the gas indoor device object sub-platform 151 may include the indoor device.

In some embodiments of the present disclosure, the method for execution quality evaluation of a smart gas work order is implemented through the IoT functional system structure of five platforms, which completes a closed loop of information flow, thereby making the IoT information processing smoother and more efficient and achieving intelligent management of the evaluation method.

It should be noted that the above descriptions of the IoT system 100 for execution quality evaluation of a smart gas work order is provided for the purpose of illustration only, and is not intended to limit the scope of the present disclosure. For those skilled in the art, various modifications or changes may be made based on the description of the present disclosure. For example, the IoT system 100 for execution quality evaluation of a smart gas work order may further include one or more other suitable components to achieve similar or different functions. However, changes and modifications do not depart from the scope of the present disclosure.

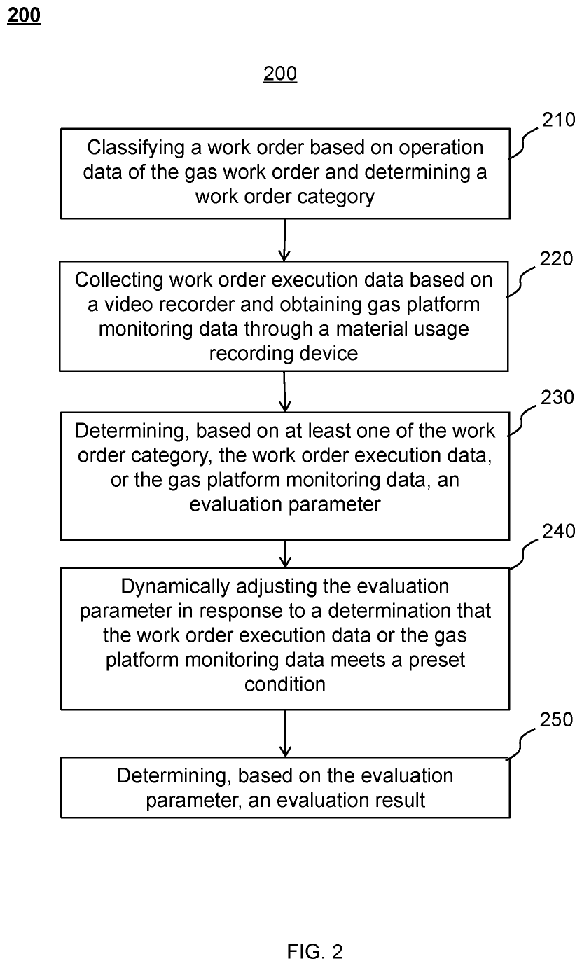

FIG. 2 is a flowchart illustrating an exemplary process for execution quality evaluation of a smart gas work order according to some embodiments of the present disclosure. In some embodiments, the process 200 is executed by the smart gas management platform, and the process 200 includes the following operations.

In 210, classifying the work order based on operation data of the gas work order and determining a work order category.

The gas work order refers to a work order related to a gas service. For example, the gas work order may be a work order related to gas maintenance, application for suspension, turn-on, installation, etc.

The operation data of the gas work order refers to data related to formulating and executing the gas work order. The operation data of the gas work order may include a creation time, an allocation time, an execution status, a work order category, etc. of the work order. The execution status may include a situation of personnel required to execute the work order, an execution duration, a situation of materials required to execute the work order, etc. The operation data of the gas work order may be recorded in a database synchronously when the work order is created.

The work order category refers to classification related to the work order.

In some embodiments, the work order category may include the work order type, a work order difficulty, a personnel demand situation, an actual executive situation, a material demand situation, or any combination thereof.

The work order type refers to a type of gas service that needs to be executed in the work order. The work order type may include a gas household installation, a gas failure, a gas annual inspection, etc.

The work order difficulty refers to a degree of difficulty for completing the current work order. The work order difficulty may be represented by a numerical value or a grade. The greater the numerical value or grade, the more difficult it is to complete the work order.

The personnel demand situation refers to a situation of staff required to complete the current work order. The personnel demand situation may include a count and qualifications of staff who are scheduled to complete the current work order. The qualification of the personnel refers to a level of employment of the staff member, e.g., a junior level, an intermediate level, a senior level, etc.

The actual executive situation refers to a situation of staff who are actually assigned to complete the current work order. The actual executive situation may include the qualification, an age, a name, etc. of each staff member who is actually assigned to complete the current work order.

The material demand situation refers to a situation of materials required to complete the current work order. For example, the material demand situation may include a type, a quantity, etc. of the required materials.

The work order category may be determined in various ways. For example, processing such as statistical analysis may be performed on the gas work order operation data of a certain work order to determine the work order type, the work order difficulty, the personnel demand situation, the actual executive situation, the material demand situation of the work order, or any combination thereof. As another example, when recording the gas work order operation data of a certain work order, at least one of the work order type, the work order difficulty, the personnel demand situation, the actual executive situation, and the material demand situation of the work order may be labeled, and the work order category may be determined according to the labeling result.

In 220, collecting work order execution data based on a video recorder and obtaining gas platform monitoring data through a material usage recording device.

The video recorder refers to a device that records actual execution of the work order. For example, the video recorder may be a video recording device, etc. The video recorder may be configured in the smart gas object platform.

The work order execution data refers to data related to the actual execution of the work order. The work order execution data may include videos, audio recordings, photos, etc. of a work order execution site.

In some embodiments, when receiving an instruction for obtaining gas device-related data, the smart gas object platform may upload the work order execution data collected by the video recorder to the smart gas management platform through the smart gas sensor network platform for processing.

The material usage recording device refers to a device recording the materials used during the actual execution of the work order. The material may include gas, etc. The material usage recording device may be configured in the smart gas object platform.

The gas platform monitoring data refers to change data of gas flow during the actual execution of the current work order. The monitoring data of the gas flow during the execution of the work order may reflect an execution quality of the work order. For example, if gas consumption is relatively great during the execution of the work order, it may be a gas leakage caused by the gas pipeline not being sealed well, indicating that the execution quality is not good.

In some embodiments, when the smart gas object platform receives the instruction for obtaining the gas device-related data, the gas platform monitoring data collected by the material usage recording device may be uploaded to the smart gas management platform through the smart gas sensor network platform for processing.

In 230, determining, based on at least one of the work order category, the work order execution data, or the gas platform monitoring data, an evaluation parameter.

The evaluation parameter refers to a parameter that evaluates the execution quality of the work order.

In some embodiments, the evaluation parameter includes a preset weighted full score, a preset item weight, a preset item full score, an item actual score, or any combination thereof.

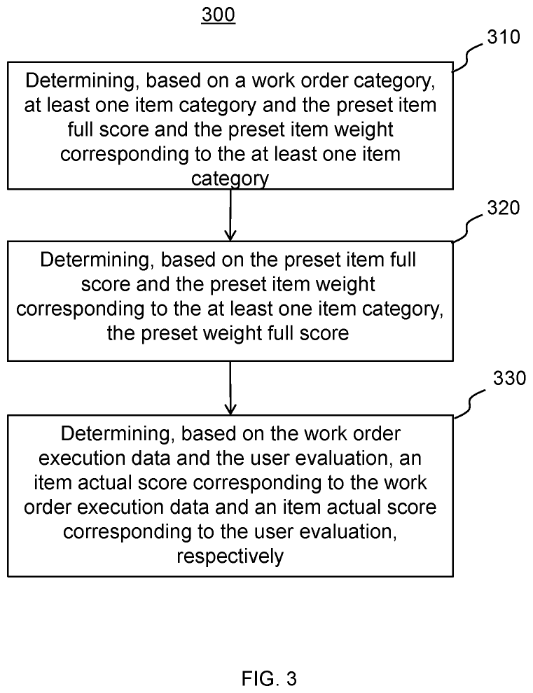

The work order can be evaluated from a plurality of aspects. For example, when a certain gas household work order is evaluated, the gas household work order may be evaluated from the work order execution data and/or a user evaluation. A project in which a work order is evaluated from a certain aspect may be called an item. In some embodiments, the work order may be evaluated from the plurality of aspects, i.e., there may be a plurality of item categories. In some embodiments, the item category may include the work order execution data, the user evaluation, etc. The user evaluation may be the user's scoring of the execution of the work order. For more descriptions on the item category and the user evaluation, please refer to FIG. 3 and its related descriptions.

The preset item weight may be a weight of each item. The preset item weights of different items may be different. The preset item weight may be determined in various ways. For example, the preset item weight may be determined according to a preset weight rule. The preset weight rule may include corresponding relationships between the work order category, the work order execution data, the gas platform monitoring data, and the preset item weight. The weight rule may be manually preset.

The preset item full score may be a preset full-score value of a certain item. The preset item full scores of different items may be different. The preset item full score may be determined in various ways. For example, the preset item full score may be determined according to a preset item full score rule. The preset item full score rule may include corresponding relationships between the work order category, the work order execution data, the gas platform monitoring data, and the preset item full score. The item full score rule may be manually preset. For more descriptions about determining the preset item full score and the preset item weight, please refer to FIG. 3 and its related descriptions.

The preset weighted full score refers to a result of weighted sum based on the preset item full score of each item category and the corresponding preset item weight. For more descriptions about the preset weighted full score, please refer to FIG. 3 and the related descriptions.

The item actual score may be an actual score of each item when the work order is actually executed.

In some embodiments, the smart gas management platform may preset a corresponding actual scoring rule based on each item category; and determine the item actual score of a certain item category by processing the work order category, the work order execution data, and the gas platform monitoring data based on the actual scoring rule corresponding to the item category. The actual scoring rule may include the corresponding relationship between the work order category, the work order execution data, the gas platform monitoring data, and the item actual score of a certain item category. The actual scoring rule may be manually preset.

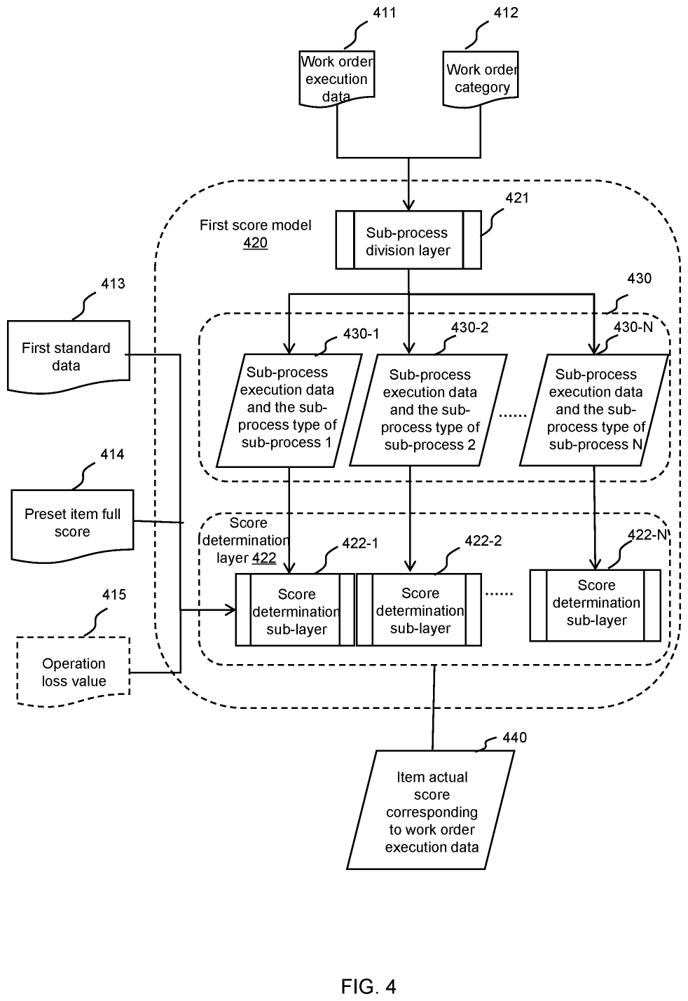

In some embodiments, the smart gas management platform may determine at least one item category and the preset item full score and the preset item weight corresponding to the at least one item category based on the work order category; determine the preset weighted full score based on the preset item full score and the preset item weight corresponding to the at least one item category; and respectively determine the item actual score corresponding to the work order execution data and the item actual score corresponding to the user evaluation based on the work order execution data and the user evaluation. For the related descriptions of determining the evaluation parameter, please refer to FIG. 4 and the related descriptions.

In 240, dynamically adjusting the evaluation parameter in response to a determination that the work order execution data and/or the gas platform monitoring data meets a preset condition.

The preset condition refers to a condition used to determine whether a major operation error occurs during the actual execution of the work order.

The major operation error refers to a misoperation that brings huge losses. In some embodiments, the major operation error may be a misoperation with economic losses exceeding an economic loss threshold and/or a misoperation with time losses exceeding a time loss threshold. The economic loss threshold and the time loss threshold may be determined manually or by the system based on prior knowledge.

In some embodiments, the preset condition may be that differences between the work order execution data and/or the gas platform monitoring data and corresponding standard data are greater than a difference threshold. The standard data may include standard data corresponding to the work order execution data, standard data corresponding to the gas platform monitoring data, etc.

In some embodiments, when the work order execution data and the gas platform monitoring data meet the preset condition, the smart gas management platform may adjust the preset item weight. For example, when the work order execution data and/or the gas platform monitoring data meet the preset condition, the preset item weight corresponding to the user evaluation may be reduced to ensure fairness of a final evaluation result.

In some embodiments, the smart gas management platform may dynamically adjust the preset item full score corresponding to the work order execution data based on the execution data of each sub-process in the work order execution data.

The sub-process refers to a certain operation during the execution of the work order. Taking a gas account opening work order as an example, the sub-process may include opening a household opening, accessing to a household pipeline, installing a hose or a corrugated pipe, installing a valve, installing an electric meter, etc.

The execution data of sub-process refers to a part of the work order execution data corresponding to the sub-process. The execution data of sub-process may be a video, an audio recording, a photo, etc. corresponding to the sub-process.

In some embodiments, when the major operation error affecting an execution effect of the work order occurs, the preset item full score of the work order execution data may be reduced, that is, a maximum score that can be obtained by the item may be reduced. When the major operation error occurs, the maximum score corresponding to the item may be reduced by reducing the preset item full score of the item corresponding to the major operation error. Even if the follow-up operations are completed with high quality, the impact of the major error on the execution quality cannot be eliminated. In this way, the fairness of the evaluation can be ensured.

In some embodiments of the present disclosure, the preset item full score may be adjusted based on the execution data of sub-process in the work order execution data, which can intensify supervision of the major error, reduce the possibility of occurrence of major error, and increase a service quality.

In some embodiments, the smart gas management platform may determine, based on the execution data of each sub-process, an operation loss value corresponding to the work order execution data; and adjust, based on the operation loss value, the preset item full score corresponding to the work order execution data.

The operation loss value may be a quantified value of the loss caused by an executor's operation error during the execution of the work order. The operation loss value may be represented by a numerical value. The greater the value, the greater the loss caused by the operation error during the execution of the work order.

The error may occur in each sub-process, thereby affecting the user's evaluation of the work order. Accordingly, each sub-process corresponds to a sub-operation loss value.

The operation loss value may be a weighted result of a plurality of sub-operation loss values. A weight of each sub-operation loss value may be manually set.

The operation loss value may be determined in various ways. For example, a value of the economic losses caused by the major operation error may be taken as the operation loss value, or time wasted by the occurrence of the major operation error may further be taken as the operation loss value.

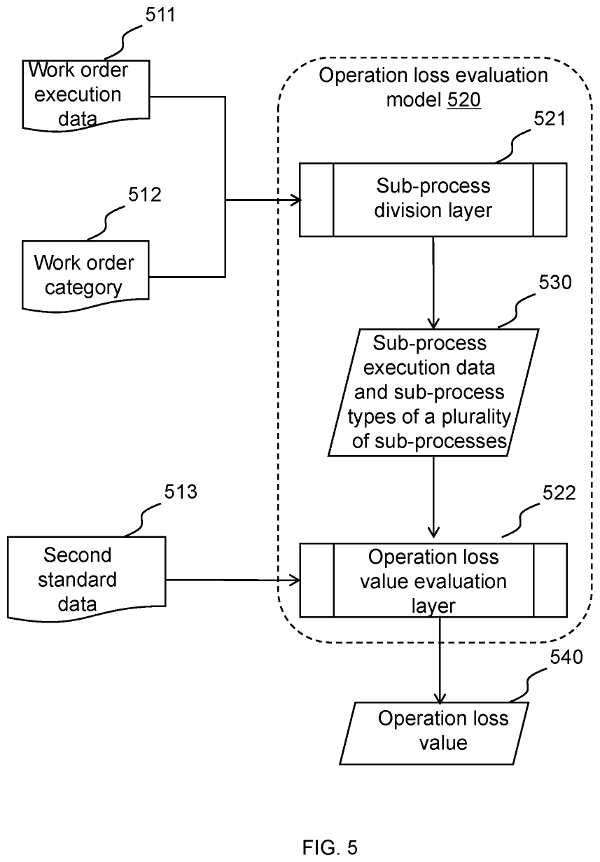

In some embodiments, the operation loss value may be determined based on an operation loss evaluation model. For descriptions about determining the operation loss value based on the operation loss evaluation model, please refer to FIG. 5 and the related descriptions.

In some embodiments, the smart gas management platform may adjust the preset item full score corresponding to the work order execution data based on the operation loss value in various ways. For example, the smart gas management platform may reduce the preset item full score corresponding to the work order execution data according to a certain adjustment ratio based on a size of the operation loss value. The greater the operation loss value, the greater the corresponding adjustment ratio. The corresponding relationship between the operation loss value and the adjustment ratio may be preset manually or by the system.

In some embodiments of the present disclosure, the preset item full score of the work order execution data may be adjusted based on the operation loss value, which can reduce the preset item full score when the major operation error occurs and objectively represent the significant negative impact of the operation error on the work order execution quality.

In 250, determining, based on the evaluation parameter, an evaluation result.

The evaluation result refers to a result obtained by evaluating the completion quality of the current work order.

The evaluation result may be determined by the item actual score and the preset item weight of each item. Exemplarily, the evaluation result may be determined by equation (1):

ε=Σᵢ₌₁ⁿ(θᵢ×γᵢ) (1)

where ε indicates the evaluation result, θᵢ and γᵢ indicate the actual item score of the i^{th} item and the corresponding preset item weight, n indicates a count of item categories, and 0≤i≤n.

In some embodiments of the present disclosure, the evaluation parameter may be determined or updated based on the relevant data (e.g., the work order execution data, the gas platform monitoring data, etc.) in the work order execution process, so that the evaluation result may be determined by considering the customer's evaluation and the actual on-site execution situation, thereby making the evaluation result more objective and reasonable.

FIG. 3 is a flowchart illustrating an exemplary process for determining an evaluation parameter according to some embodiments of the present disclosure. In some embodiments, the process 300 is executed by the smart gas management platform, and the process 300 includes the following operations.

In 310, determining, based on a work order category, at least one item category and the preset item full score and the preset item weight corresponding to the at least one item category.

The item category refers to a category of evaluation item used to evaluate a work order.

In some embodiments, the at least one item category includes at least one of work order execution data or a user evaluation. For more descriptions about the work order execution data, please refer to FIG. 2 and its related descriptions.

The user evaluation refers to a user's evaluation of the current work order. The user evaluation may be represented by a numerical value or a letter, for example, the user evaluation may be grade A, corresponding to 90-100 points, etc.

In some embodiments, the smart gas management platform may determine the at least one item category and the corresponding preset item full score and the preset item weight based on the work order category through a preset comparison table. In some embodiments, the preset comparison table includes corresponding relationships between a plurality of different reference work order categories and reference item categories and corresponding relationships between reference item categories and reference item weights and reference item full scores.

In some embodiments, the smart gas management platform may construct the preset comparison table based on prior knowledge or historical data (e.g., historical evaluation data evaluating historical work order categories). In some embodiments, the smart gas management platform may retrieve the preset comparison table based on the work order category, determine the reference work order category that matches the work order category, further determine one or more reference work order categories corresponding to the reference work order category, and determine the reference item weight(s) and the reference item full score(s) corresponding to the one or more reference item categories as at least one final item category and the corresponding preset item full score(s) and the preset item weight(s).

In some embodiments, the smart gas management platform may determine the preset item weight based on the work order category and a data volume of the item category.

The data volume of the item category refers to a volume of data related to each item. The data volume of the item category may include the data volume related to the work order execution data, the data volume related to the user evaluation, etc. In some embodiments, the data volume of the item category may be obtained from historical records.

The data volume may be determined according to a data storage volume, a count of data categories, etc. For example, the greater the count of sub-processes in the work order execution data, the greater the storage volume the work order execution data occupies, and accordingly, the greater the data volume corresponding to the work order execution data. As another example, the more data categories monitored by the gas platform monitoring data, the greater the storage volume the gas platform monitoring data occupies, and accordingly, the greater the data volume corresponding to the gas platform monitoring data.

In some embodiments, the preset item weight may be positively correlated to the work order category and the data volume of the item category. For example, when the work order category of a certain work order is a work order difficulty and the work order difficulty is relatively high, the greater the data volume of the work order execution data of the work order, the higher the importance of evaluating the processing quality of the work order, and the greater the corresponding preset item weight.

In some embodiments of the present disclosure, the preset item weight may be determined based on the work order category and the data volume of each item category in a work order historical execution situation, which makes the evaluation result more reasonable.

In some embodiments, the smart gas management platform may determine the preset item weight by iteratively updating an initial weight through a preset algorithm. The initial weight may be the preset item weight determined based on the manner described above.

In some embodiments, the smart gas management platform may determine an updated preset item weight by iteratively updating the initial weight using the preset algorithm. An exemplary preset algorithm may include the following operations.

In S1, obtaining, based on sample work order execution data, a plurality of reference evaluation results corresponding to the sample work order execution data; and determining, based on an initial weight and an item actual score corresponding to each item category in the sample work order, an initial evaluation result. The initial weight and the item actual score corresponding to each item category may be determined through other embodiments, which may be described in the operation 330 and the related descriptions in FIG. 4.

The reference evaluation result refers to a result of manual evaluation of the work order execution data. The reference evaluation result may be obtained by manually watching video data corresponding to the sample work order execution data and manually scoring. For example, the manual scoring may be performed based on time costs and consumable costs of the sample work order execution and an execution effect in the video data.

The initial evaluation result may be a weighted result of the initial weight and the item actual score corresponding to each item category in the sample work order.

In S2, obtaining a loss value based on the reference evaluation result and the initial evaluation result.

In some embodiments, the initial evaluation result may be a result of weighted sum based on the item actual scores and the initial weights corresponding to the work order execution data and the user evaluation.

The loss value refers to a difference between the initial evaluation result and the reference evaluation result.

In S3, determining a mapping relationship between the loss value and the preset item weight, and obtaining a loss function L(ωx) of the loss value with respect to the preset item weight through fitting and matching, where ωx indicates a weight of the x^{th} item.

In S4, updating the preset item weight based on a learning rate.

Exemplarily, the updated preset item weight may be determined by equation (2):

$${ω}_{i + 1}^{x} = {ω}_{i}^{x} - α \times \frac{d L ( {ω}^{x} )}{d {ω}_{i}^{x}} \qquad ( 2 )$$

where ωᵢ₊₁^{x} indicates a preset item weight of x^{th} item after (i+1)^{th} update, ωᵢ indicates the preset item weight of x^{th} item after i^{th} update, and α indicates the leaning rate of the preset item weight during the iterative update. The learning rate may be used to evaluate a rate of change of the preset item weight in each iteration. The learning rate may be determined based on prior knowledge or historical experience.

In some embodiments, the learning rate may be related to an action complexity of the work order execution data. When the action complexity of the work order execution data is relatively high, the learning rate may be set relatively small; when the action complexity of the work order execution data is relatively low, the learning rate may be set relatively great. The action complexity refers to a complexity of actions included in the work order execution data corresponding to the work order execution process. For more descriptions on the action complexity, please refer to the related descriptions of the sub-process action complexity in FIG. 4.

The learning rate is set to be relative to the action complexity of the work order execution data, which may fully consider the influence of the complexity of the work order execution process on the execution quality. For example, when the action complexity of the work order execution data is relatively high, the learning rate may be set relatively small, so that the weight of the item may be as accurate as possible during the iteration.

In S5, repeating the above operations S1-S4, updating the loss value according to the updated preset item weight, stopping the iteration when the loss value satisfies a preset condition, and outputting the final preset item weight. The preset condition may be the convergence of the loss value, the loss value being smaller than a preset threshold, etc. Through the iteration, the loss value may be continuously reduced, that is, the initial evaluation result is closer to the reference evaluation result.

In some embodiments, the smart gas management platform may use the preset item weight output at an end of the iteration as the final preset item weight.

In some embodiments of the present disclosure, by iteratively updating and determining the preset item weight, the most objective and reasonable preset item weight may be obtained, thereby making the final evaluation result more objective.

In 320, determining, based on the preset item full score and the preset item weight corresponding to the at least one item category, the preset weighted full score.

The preset weighted full score may be determined by the preset item full score and the preset item weight of the at least one item category. When the item category includes the work order execution data and the user evaluation, the preset weighted full score is the weighted result of the preset item full score corresponding to the work order execution data and the preset item full score corresponding to the user evaluation.

Exemplarily, the preset weighted full score may be determined by equation (3):

δ=Σᵢ₌₁ⁿ(βᵢ×γᵢ) (3)

where δ indicates the preset weighted full score, βᵢ and γᵢ respectively indicate the preset full score and the preset item weight of the i^{th} item, n indicates a count of item categories, and 0≤i≤n.

When the item category includes the work order execution data and the user evaluation, the preset weighted full score is a weighted result of the preset item full score corresponding to the work order execution data and the preset item full score corresponding to the user evaluation. For more descriptions about the preset weighted full score and the preset item weight, please refer to FIG. 2 and the related descriptions.

In 330, determining the item actual score corresponding to the work order execution data and the item actual score corresponding to the user evaluation based on the work order execution data and the user evaluation, respectively.

In some embodiments, the smart gas management platform may determine the item actual score corresponding to the work order execution data based on the work order execution data. For example, the work order execution data collected by a video recorder may be manually labeled to determine the actual item score corresponding to the work order execution data.

In some embodiments, the smart gas management platform may determine the actual item score corresponding to the user evaluation based on the user evaluation. For example, the user evaluation may be converted into a score to obtain the item actual score corresponding to the user evaluation. A conversion relationship between the user evaluation and the score may be preset.

In some embodiments, the smart gas management platform may determine the item actual score corresponding to the work order execution data by processing the work order execution data based on a first score model. For descriptions about determining the item actual score corresponding to the work order execution data based on the first score model, please refer to FIG. 4 and the related descriptions.

In some embodiments of the present disclosure, the item category may be divided into the work order execution data and the user evaluation, and the corresponding item actual scores may be respectively calculated based on the work order execution data and the user evaluation, which can make the evaluation result consider the actual situation of the work order execution and a customer evaluation and make the evaluation result fairer and more reasonable.

In some embodiments, at least one item category may further include the gas platform monitoring data, a work order duration, a work order completion time, or any combination thereof.

Correspondingly, when determining the evaluation result based on the evaluation parameter, the smart gas management platform may determine the evaluation result based on the item actual score and the preset item weight of at least one of the work order execution data, the user evaluation, the gas platform monitoring data, the work order duration, or the work order completion time. For example, the smart gas management platform may determine the evaluation result by weighting the item actual score and the preset item weight corresponding to at least one of the work order execution data, the user evaluation, the gas platform monitoring data, the work order duration, or the work order completion time. More descriptions on determining the evaluation result may be found in FIG. 2 and the related descriptions.

In some embodiments, the item actual score corresponding to the gas platform monitoring data may be obtained through a preset relationship. The preset relationship refers to a corresponding relationship between a difference between the gas platform monitoring data and standard detection data and the item actual score. Accordingly, after the difference between the gas platform monitoring data and the standard detection data is determined, the item actual score corresponding to the gas platform monitoring data may be determined according to the preset relationship. The preset relationship may be manually set. For the relevant descriptions of the gas platform monitoring data, please refer to the related descriptions in FIG. 2.

In some embodiments, the item actual score corresponding to the gas platform monitoring data may be determined based on a second score model. An input of the second score model may include the gas platform monitoring data and the gas work order category, and an output may include the item actual score corresponding to the gas platform monitoring data. The second score model may be a machine learning model, for example, the second score model may be a deep neural network model.

In some embodiments, the second score model may be obtained through training. For example, a second training sample may be input to an initial second score model, and a loss function may be established based on a second label and the output of the initial second score model, a parameter of the initial second score model may be updated, and the model training is completed when the loss function of the initial second score model meets a preset condition. The preset condition may be that the loss function converges, a count of iterations reaches a threshold, etc.

In some embodiments, the second training sample may include historical gas platform monitoring data and a historical work order category, and the second training sample may be obtained based on historical data. The second label may be a historical item actual score corresponding to the historical gas platform monitoring data. The second label may be labeled manually.

The work order duration refers to an actual time taken for the current work order from start to completion. The work order duration may be a sum of a duration of each sub-process.

In some embodiments, the item actual score corresponding to the work order duration may be determined based on a preset first scoring rule. An exemplary first scoring rule includes: setting a standard duration corresponding to each sub-process of the gas work order; determining a corresponding score of the sub-process based on a difference between the standard duration of each sub-process and the duration of the sub-process; adding up the scores corresponding to the a plurality of sub-processes to obtain the actual item score corresponding to the work order duration. The standard duration may be preset. A corresponding relationship between the difference between the standard duration and the duration and the score may be preset.

The work order completion time refers to a time when the current work order is actually completed.

In some embodiments, the item actual score corresponding to the work order completion time may be determined based on a preset second scoring rule. An exemplary second scoring rule includes: setting a required completion time corresponding to each work order; determining, based on a relationship between the work order completion time and the required completion time, the item actual score corresponding to the work order completion time. When the work order completion time is before the required completion time, the actual item score may be the preset item full score. When the work order completion time is after the required completion time, a deduction standard may be determined based on the work order completion time, and then the actual item score corresponding to the work order completion time may be determined based on the deduction standard and the preset item full score.

The required completion time refers to a time when completion a requirement set for each work order is completed. The required completion time may be determined based on a start time of the work order and the standard duration of the work order, and the standard duration may be manually set.

The preset deduction standard may include a corresponding relationship between a length of a lagging time period and a deduction score. For example, the preset deduction standard may be that the longer the lagging time period is, the more the scores are accordingly deducted. The length of the lagging time period may be determined by a difference between the work order completion time and the required completion time.

In some embodiments of the present disclosure, the actual item scores corresponding to the gas platform monitoring data, the duration of the work order, and the completion time of the work order may be determined, which can evaluate the work order execution situation from the plurality of aspects, thereby avoiding inaccuracy of a single evaluation result and effectively improving a reliability and authenticity of the work order evaluation system.

FIG. 4 is a schematic diagram illustrating an exemplary processing process of a first score model according to some embodiments of the present disclosure.

In some embodiments, the smart gas management platform may determine an item actual score 440 corresponding to work order execution data by processing the work order execution data 411 based on the first score model 420.

The first score model 420 may be a machine learning model. In some embodiments, the first score model 420 may include various possible models such as a recurrent neural network (RNN) model, a deep neural network (DNN) model, a convolutional neural network (CNN) model, or the like, or any combination thereof.

In some embodiments, an input of the first score model 420 includes the work order execution data 411, a work order category 412, first standard data 413, and a preset item full score 414, and an output includes the item actual score 440 corresponding to the work order execution data. For more descriptions on the first standard data, please refer to the relevant part below.

In some embodiments, the first score model 420 includes a sub-process division layer 421 and a score determination layer 422. An output of the sub-process division layer 421 is configured as a part of an input of the score determination layer 422, and an output of the score determination layer 422 is a final output of the first score model 420.

The sub-process division layer 421 may be a machine learning model such as a CNN model, a DNN model, etc. In some embodiments, the input of the sub-process division layer 421 includes the work order execution data 411 and the work order category 412, and the output includes the sub-process execution data and sub-process types 430 of a plurality of sub-processes. For example, the sub-process execution data and the sub-process types 430 of the plurality of sub-processes includes sub-process execution data and a sub-process type 430-1 of sub-process 1, sub-process execution data and a sub-process type 430-2 of sub-process 2, . . . , sub-process execution data and a sub-process type 430-N of sub-process N.

The sub-process type refers to a process type corresponding to the execution data of a certain sub-process. For example, a process type may be opening a household opening, accessing to a household pipeline, installing a hose or a corrugated pipe, installing a valve, installing an electric meter, etc.

For more descriptions about the sub-process execution data, the work order execution data, and the work order category, please refer to FIG. 2, FIG. 3, and their related descriptions.

The score determination layer 422 may be a machine learning model such as a CNN model, a DNN model, etc. In some embodiments, an input of the score determination layer 422 includes the sub-process execution data and the sub-process types 430 of the plurality of sub-processes, the first standard data 413 corresponding to the sub-process types, and the preset item full score 414. The preset item full score 414 refers to a preset item full score corresponding to the work order execution data. For more descriptions about the preset item full score, please refer to FIG. 2 and its related descriptions.

The first standard data is standard data used to determine whether a task of the work order is completed according to a preset requirement during the execution of the work order. The preset requirement may be set manually. Each sub-process may correspond to a piece of first standard data. For example, the first standard data corresponding to an inspection process may be standard data used to determine whether an operation of the inspection process is completed according to a preset requirement.

In some embodiments, the first standard data may be determined based on historical data. For example, the sub-process execution data of a certain sub-process completed according to the preset requirement in the historical data or the sub-process execution data corresponding to an experienced executive may be determined as the first standard data of the sub-process.

In some embodiments, the first standard data input to the score determination layer 422 may be in a form of a vector. A plurality of elements in the vector respectively represent the first standard data corresponding to different sub-processes. The first standard data in the vector form may be obtained through an embedding layer. A processing process of the embedding layer is essentially a process of extracting depth information. In some embodiments, the embedding layer may be obtained through joint training with the sub-process division layer and the score determination layer. For example, during training, the first standard data may be first input into the embedding layer, and the first standard data in vector form output by the embedding layer may be input into an initial score determination layer. More descriptions regarding the subsequent joint training process may be found below.

In some embodiments, the input of the score determination layer 422 also includes an operation loss value 415. For more descriptions about the operation loss value, please refer to FIG. 5 and the related description.

In some embodiments, the score determination layer 422 may include a plurality of score determination sub-layers, for example, the score determination layer 422 may include a score determination sub-layer 422-1, a score determination sub-layer 422-2, . . . , a score determination sub-layer 422-N.

In some embodiments, the different score determination sub-layers are used to process different sub-process execution data and the sub-process types. For example, the score determination sub-layer 422-1 may be used to process the sub-process execution data and the sub-process type 430-1 of the sub-process 1, the score determination sub-layer 422-2 may be used to process the sub-process execution data and the sub-process type 430-2 of the sub-process 2, . . . , the score determination sub-layer 422-N may be used to process the sub-process execution data and the sub-process type 430-N of the sub-process N.

In some embodiments, the different score determination sub-layers may be used to process the first standard data of different sub-processes. Accordingly, the first standard data of each sub-process may be input to the score determination sub-layer corresponding to the sub-process.

In some embodiments, parameters of the sub-process division layer 421 and the score determination layer 422 of the first score model 420 may be obtained through joint training.

In some embodiments, sample data of the first score model may include a plurality of first training samples with a first label. The first training sample may include sample work order execution data, sample work order category, sample first standard data, and sample preset item full score. The sample preset item full score is a preset item full score corresponding to the sample work order execution data. The sample first standard data may include the first standard data respectively corresponding to the plurality of sub-processes in the sample work order execution data. The first label may be the item actual score corresponding to the sample work order execution data.

An exemplary joint training process may include: inputting the sample work order execution data and the sample work order category into an initial sub-process division layer and obtaining the sub-process execution data and the sub-process types output by the initial sub-process division layer; inputting the sub-process execution data and the sub-process type output by the initial sub-process division layer together with the sample first standard data and the sample preset item full score into the initial score determination layer and obtaining the item actual score corresponding to the sample work order execution data output by the initial score determination layer; constructing a loss function based on the first label and the output of the initial score determination layer; and iteratively and synchronously updating parameters of the initial sub-process division layer and the initial score determination layer based on the loss function through a gradient descend or other manners. When the loss function satisfies a preset condition of the end of training, the model training is completed, and trained sub-process division layer 421 and the score determination layer 422 may be obtained. The preset condition may be that the loss function converges, a count of iterations reaches a threshold of the count of iterations, etc.

In some embodiments, the first training sample may be determined based on historical gas operation data. For example, historical work order execution data, historical work order category, historical first standard data, and historical preset item full score in the historical gas operation data may be used as the first training sample.

In some embodiments, a manner for determining the training label (i.e., the first label) of the score determination layer includes: scoring, based on a difference between sub-process execution data of each sample sub-process of the sample work order execution data and the first standard data, sub-process execution data of each sub-process; and determining, based on a score and a correction coefficient of the sub-process execution data of each sample sub-process, the item actual score corresponding to the sample work order execution data. The item actual score is the training label of the score determination layer.

In some embodiments, the scoring sub-process execution data of each sub-process may be performed based on a preset scoring rule. An exemplary scoring rule includes: comparing the sub-process execution data with sub-process standard execution data, and the greater the difference, the lower the score of the corresponding sub-process execution data. The scoring rule may be manually set.

The correction coefficient refers to a coefficient used to correct deviation.

In some embodiments, sub-process execution data of different sample sub-processes corresponds to different correction coefficients. In some embodiments, the correction coefficient may be manually set.

In some embodiments, the correction coefficient may be determined based on a sub-process action complexity of the sample sub-process.

The sub-process action complexity refers to a complexity of actions included in the sub-process. For example, the more actions a sub-process contains, the more complex the actions of the sub-process. The sub-process action complexity may be represented by a numerical value. The greater the value, the higher the sub-process action complexity.

In some embodiments, the sub-process action complexity may be determined by a video code flow of the corresponding sample sub-process.

The video code flow refers to a data flow per unit time after a video image is coded and compressed. The video code flow of the sub-process may be determined through relevant work data transmitted over a network.

The sub-process action complexity may be quickly determined through the code flow. The greater the video code flow of the sub-process, the less compression of an original image, and the more information the video code flow contains, the more complex the corresponding sub-process action, that is, the greater the sub-process action complexity.

In some embodiments, the correction coefficient may be positively correlated with the sub-process action complexity. The greater the sub-process action complexity, the more complex the corresponding sub-process action, and the more important the sub-process is to the completion of the entire work order, the greater the corresponding correction coefficient.

In some embodiments, the item actual score corresponding to a certain sample work order execution data may be determined based on a product of the score of sub-process execution data of each sample sub-process and the corresponding correction coefficient.

In some embodiments of the present disclosure, the label may be determined by scoring based on the difference between the first standard data and the sub-process execution data of each sample sub-process, so that the training label is more objective. The correction coefficient is determined based on the sub-process action complexity, and the item actual score of the work order execution data is further corrected, so that the score of the more complex and difficult process is higher, which makes the item actual score more objective and reasonable. At the same time, the item actual score of the work order execution data may be determined through the first score model, which can improve the efficiency and accuracy of determining the item actual score.

FIG. 5 is a schematic diagram illustrating an exemplary processing process of an operational loss evaluation model according to some embodiments of the present disclosure.

In some embodiments, the smart gas management platform may determine an operation loss value corresponding to work order execution data by processing the work order execution data and a work order category based on the operation loss evaluation model 520.

The operation loss evaluation model is a machine learning model. In some embodiments, the operation loss evaluation model may include various feasible models such as an RNN model, a DNN model, a CNN model, or the like, or any combination thereof.

In some embodiments, an input of the operation loss evaluation model 520 may include the work order execution data 511 and the work order category 512, and an output is the operation loss value 540 corresponding to the work order execution data. In some embodiments, the input of the operation loss evaluation model 520 may further include second standard data 513.

The second standard data is standard data used to determine whether a major operation error occurs during execution of the work order. Each sub-process may correspond to a piece of second standard data. For example, the second standard data corresponding to an inspection process may be standard data used to determine whether there is a major operation error in the inspection process.

In some instances, the second standard data may be determined based on historical data. For example, historical operation loss values corresponding to various errors in a certain sub-process during the historical execution process are counted, and the historical sub-process execution data whose historical operation loss value meets a preset condition is determined as the second standard data of the sub-process. The preset condition may be that the historical operation loss value is equal to an appropriate value selected from a plurality of historical operation loss values, e.g., an intermediate value or an average value.

For more descriptions on the operation loss value, the work order execution data, and the work order category, please refer to FIG. 2 and the related descriptions.

In some embodiments, the operation loss evaluation model 520 may include a sub-process division layer 521 and an operation loss value evaluation layer 522. An output of the sub-process division layer 521 is a part of an input of the operation loss evaluation layer 522, and an output of the operation loss evaluation layer 522 is a final output of the operation loss evaluation model 520.

The sub-process division layer 521 may be a machine learning model, e.g., a CNN model, a DNN model, etc. In some embodiments, an input of the sub-process division layer 521 includes the work order execution data 511 and the work order category 512, and the output includes sub-process execution data and sub-process types 530 of a plurality of sub-processes. For more descriptions on the sub-process division layer, the sub-process execution data, and the sub-process type, please refer to FIG. 4 and the related descriptions.

The operation loss evaluation layer 522 may be a machine learning model, e.g., a CNN model, a DNN model, etc. In some embodiments, the input of the operation loss evaluation layer 522 may include sub-process execution data and sub-process types 530 of the plurality of sub-processes and the second standard data 513, and the output includes the operation loss value 540 corresponding to the work order execution data.

In some embodiments, the second standard data input to the operation loss value determination layer 522 may be in a form of a vector. A plurality of elements in the vector respectively represent the second standard data corresponding to different sub-processes. The second standard data in the vector form may be obtained through an embedding layer. For more descriptions about the embedding layer, please refer to FIG. 4 and its related descriptions.

In some embodiments, parameters of the sub-process division layer 521 and the operation loss value evaluation layer 522 of the operation loss evaluation model 520 may be obtained through joint training.

In some embodiments, sample data of the operation loss evaluation model 520 may include a plurality of third training samples with a third label. The third training sample may include sample work order execution data, sample work order category, and sample second standard data, and the third label may be an actual operation loss value corresponding to the sample work order execution data.

In some embodiments, the third training sample and the third label may be determined based on historical data where a major operation error occurs. For example, historical work order execution data, a historical work order category, and historical second standard data in the historical data with the major operation error are used as the third training sample, and the historical operation loss value corresponding to the historical work order execution data is used as the third label. In some embodiments, the historical operation loss value may be obtained by manually counting actual losses generated during the execution of the historical work order. For example, economic losses caused by a material waste and time losses caused by a time waste may be counted during the execution of the historical work order, and the economic losses and the time losses may be quantified as the historical operation loss value.

In some embodiments, an exemplary joint training process may include: inputting the sample work order execution data and the sample work order category into an initial sub-process division layer and obtaining the sub-process execution data and the sub-process type output by the initial sub-process division layer; inputting the sub-process execution data and the sub-process types of the plurality of sub-process output by the initial sub-process division layer into an initial operation loss value determination layer together with the sample second standard data and obtaining the operation loss value corresponding to the sample work order execution data output by the initial operation loss value determination layer, constructing a loss function based on the third label and the output of the initial operation loss value determination layer, and iteratively and synchronously updating the initial sub-process division layer and the initial operation loss value determination layer based on the loss function through a gradient descent or other manners. When the loss function satisfies a preset condition of the end of the training, the model training is completed, and trained sub-process division layer 521 and the operation loss evaluation layer 522 are obtained. The preset condition may be that the loss function converges, a count of iterations reaches a threshold of the count of iterations, etc.

In some embodiments of the present disclosure, the operation loss value corresponding to the work order execution data is determined based on the trained operation loss evaluation model, and the operation loss value corresponding to the work order execution data may be determined based on a great number of extensive features, so as to reduce manual errors and obtain a more accurate operation loss value, which helps to adjust the preset item full score of the work order execution data based on the operation loss value and avoids the impact caused by the major operation errors on the work order execution quality.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for execution quality evaluation of a smart gas work order, wherein the method is executed by an Internet of Things (IoT) system for execution quality evaluation of a smart gas work order and the method comprises:
classifying the work order based on operation data of the gas work order and determining a work order category, the work order category including at least one of a work order type, a work order difficulty, a personnel demand situation, an actual executive situation, or a material demand situation;
collecting work order execution data based on a video recorder and obtaining gas platform monitoring data through a material usage recording device;
determining, based on at least one of the work order category, the work order execution data, or the gas platform monitoring data, an evaluation parameter, wherein the evaluation parameter includes at least one of a preset weighted full score, a preset item weight, a preset item full score, or an item actual score;
dynamically adjusting the evaluation parameter in response to a determination that the work order execution data or the gas platform monitoring data meets a preset condition; and
determining, based on the evaluation parameter, an evaluation result.

2. The method of claim 1, wherein the IoT system for execution quality evaluation of a smart gas work order includes a smart gas user platform, a smart gas service platform, a smart gas management platform, a smart gas sensor network platform, and a smart gas object platform that interact in turn, wherein
the smart gas user platform being configured to send feedback information of a gas user to a smart gas usage service sub-platform comprises:
issuing, based on the smart gas user platform, a query instruction for gas operation management information to the smart gas management platform through the smart gas service platform;
in response to the query instruction for the operation management information, issuing, based on the smart gas management platform, an instruction for obtaining gas device-related data to the smart gas object platform through the smart gas sensor network platform and receiving the gas device-related data uploaded by the smart gas object platform; and
obtaining the gas operation management information by processing the gas device-related data based on the smart gas management platform and uploading the gas operation management information to the smart gas user platform through the smart gas service platform.

3. The method of claim 1, wherein the determining, based on at least one of the work order category, the work order execution data, or the gas platform monitoring data, an evaluation parameter comprises:
determining, based on the work order category, at least one item category and the preset item full score and the preset item weight corresponding to the at least one item category, wherein the at least one item category includes at least one of the work order execution data or a user evaluation;
determining, based on the preset item full score and the preset item weight corresponding to the at least one item category, the preset weighted full score; and
determining, based on the work order execution data and the user evaluation, an item actual score corresponding to the work order execution data and an item actual score corresponding to the user evaluation, respectively.

4. The method of claim 3, wherein the determining, based on the work order execution data, an item actual score corresponding to the work order execution data comprises:
determining the item actual score corresponding to the work order execution data by processing the work order execution data based on a first score model, wherein the first score model is a machine learning model and the first score model includes a sub-process division layer and a score determination layer;
an input of the sub-process division layer includes the work order execution data and the work order category, and an output includes sub-process execution data and sub-process types of a plurality of sub-processes; and
an input of the score determination layer includes the sub-process execution data and the sub-process types of the plurality of sub-processes, first standard data corresponding to each sub-process category, and the preset item full score, and an output includes the item actual score corresponding to the work order execution data.

5. The method of claim 4, wherein a training label of the score determination layer includes an item actual score corresponding to sample work order execution data and determining the training label comprises:
scoring, based on a difference between sub-process execution data of each sample sub-process of the sample work order execution data and the first standard data, sub-process execution data of each sub-process; and
determining, based on a score and a correction coefficient of the sub-process execution data of each sample sub-process, the item actual score corresponding to the sample work order execution data, wherein sub-process execution data of different sample sub-processes corresponds to different correction coefficients, the correction coefficient is determined based on a sub-process action complexity, and the sub-process action complexity is determined by a video code flow of the corresponding sample sub-process.

6. The method of claim 3, wherein the at least one item category further includes at least one of the gas platform monitoring data, a work order duration, or a work order completion time.

7. The method of claim 3, wherein the determining, based on the work order category, the preset item weight comprises:
determining, based on the work order category and a data volume of the item category, the preset item weight.

8. The method of claim 7, wherein the method comprises:
obtaining an initial weight; and
determining the preset item weight by iteratively updating the initial weight through a preset algorithm.

9. The method of claim 1, wherein the dynamically adjusting the evaluation parameter comprises:
dynamically adjusting, based on execution data of each sub-process in the work order execution data, the preset item full score corresponding to the work order execution data.

10. The method of claim 9, wherein the dynamically adjusting, based on execution data of each sub-process in the work order execution data, the preset item full score corresponding to the work order execution data comprises:
determining, based on the execution data of each sub-process, an operation loss value corresponding to the work order execution data; and
adjusting, based on the operation loss value, the preset sub-item full score corresponding to the work order execution data.

11. The method of claim 10, wherein the determining an operation loss value comprises:
determining the operation loss value corresponding to the work order execution data by respectively processing the work order execution data and the work order category based on an operation loss evaluation model, the operation loss evaluation model being a machine learning model and the first score model including a sub-process division layer and an operation loss value evaluation layer; wherein
an input of the sub-process division layer includes the work order execution data and the work order category and an output includes sub-process execution data and sub-process types of a plurality of sub-processes; and
an input of the operation loss value evaluation layer includes the sub-process execution data and the sub-process types of the plurality of sub-processes, second standard data, and an output includes the operation loss value corresponding to the work order execution data.

12. An Internet of Things (IoT) system for execution quality evaluation of a smart gas work order, comprising a smart gas user platform, a smart gas service platform, a smart gas management platform, and a smart gas sensor network platform and a smart gas object platform that interact in turn, wherein
the smart gas user platform is configured to issue a query instruction for gas operation management information to the smart gas management platform through the smart gas service platform;
the smart gas management platform is configured to, in response to the query instruction for the operation management information, issue an instruction for obtaining gas device-related data to the smart gas object platform through the smart gas sensor network platform and receive the gas device-related data uploaded by the smart gas object platform; obtain the gas operation management information by processing the gas device-related data based on the smart gas management platform; and upload the gas operation management information to the smart gas user platform through the smart gas service platform; and
the gas device-related data at least includes work order execution data, the gas operation management information includes an evaluation result, and determining the evaluation result includes:
classifying the work order based on the operation data of the gas work order and determining a work order category, the work order category including at least one of a work order type, a work order difficulty, a personnel demand situation, an actual executive situation, or a material demand situation;
collecting the work order execution data based on a video recorder and obtaining gas platform monitoring data through a material usage recording device;
determining, based on at least one of the work order category, the work order execution data, or the gas platform monitoring data, an evaluation parameter, wherein the evaluation parameter includes at least one of a preset weighted full score, a preset item weight, a preset item full score, or an item actual score;
dynamically adjusting the evaluation parameter in response to a determination that work order execution data or the gas platform monitoring data meets a preset condition; and
determining, based on the evaluation parameter, an evaluation result.

13. The system of claim 12, wherein the smart gas management platform is configured to:
determine, based on the work order category, at least one item category and the preset item full score and the preset item weight corresponding to the at least one item category, wherein the at least one item category includes at least one of the work order execution data or a user evaluation;
determine, based on the preset item full score and the preset item weight corresponding to the at least one item category, the preset weighted full score; and
determine, based on the work order execution data and the user evaluation, an item actual score corresponding to the work order execution data and an item actual score corresponding to the user evaluation on data and the user evaluation, respectively.

14. The system of claim 13, wherein the smart gas management platform is configured to:
determine the item actual score corresponding to the work order execution data by processing the work order execution data based on a first score model, wherein the first score model is a machine learning model and the first score model includes a sub-process division layer and a score determination layer;
an input of the sub-process division layer includes the work order execution data and the work order category, and an output includes sub-process execution data and sub-process types of a plurality of sub-processes;
an input of the score determination layer includes the sub-process execution data and the sub-process types of the plurality of sub-processes, first standard data corresponding to each sub-process category, and the preset item full score, and an output includes the item actual score corresponding to the work order execution data.

15. The system of claim 14, wherein a training label of the score determination layer includes an item actual score corresponding to sample work order execution data and determining the training label comprises:
scoring, based on a difference between sub-process execution data of each sample sub-process of the sample work order execution data and the first standard data, sub-process execution data of each sub-process; and
determining, based on a score and a correction coefficient of the sub-process execution data of each sample sub-process, the item actual score corresponding to the sample work order execution data, wherein sub-process execution data of different sample sub-processes corresponds to different correction coefficients, the correction coefficient is determined based on a sub-process action complexity, and the sub-process action complexity is determined by a video code flow of the corresponding sample sub-process.

16. The system of claim 13, wherein the at least one item category further includes at least one of the gas platform monitoring data, a work order duration, or a work order completion time.

17. The system of claim 13, wherein the smart gas management platform is configured to:
determine, based on the work order category and a data volume of the item category, the preset item weight.

18. The system of claim 17, wherein the smart gas management platform is configured to:
obtain an initial weight; and
determine the preset item weight by iteratively updating the initial weight through a preset algorithm.

19. The system of claim 12, wherein the smart gas management platform is configured to:
dynamically adjust, based on execution data of each sub-process in the work order execution data, the preset item full score corresponding to the work order execution data.

20. A non-transitory computer-readable storage medium storing computer instructions, wherein when reading the computer instructions in the storage medium, a computer implements the method for execution quality evaluation of a smart gas work order according to claim 1.
